(19) United States
(12) Patent Application Publication
(10) Pub. No.: US 2026/0241771 A1
(43) Pub. Date: Aug. 20, 2026

(54) VEHICLE RADIATIVE COOLING DEVICE

(71) Applicant: NISSAN MOTOR CO., LTD., Yokohama-shi, Kanagawa (JP)

(72) Inventors: Tomoya OHARA, Kanagawa (JP); Moemi SAMATA, Kanagawa (JP); Susumu MIURA, Kanagawa (JP)

(73) Assignee: NISSAN MOTOR CO., LTD., Yokohama-shi, Kanagawa (JP)

(21) Appl. No.: 19/471,576

(22) PCT Filed: Apr. 3, 2023
(86) PCT No.: PCT/JP2023/013823

§ 371 Date: Oct. 1, 2025

(51) Int. Cl. B60H 1/32; F25B 23/00

(52) U.S. Cl. CPC B60H 1/32; F25B 23/003

(57) ABSTRACT

A vehicle radiative cooling device includes: a roof panel of a vehicle provided with a radiative cooling layer on an outer surface; a roof trim disposed along a vehicle interior side surface of the roof panel; a cooling air space; a temperature variable portion disposed at the front or rear of the vehicle interior and whose temperature can rise due to solar radiation; a pillar trim disposed along the vehicle interior side surface of a pillar; an air intake port disposed adjacent to the temperature variable portion in the pillar trim; a space forming member disposed in a space between the air intake port and the cooling air space, surrounded by the pillar and pillar trim and forming a circulation space; and an airflow generator disposed in the cooling air space and generating an air flow from the air intake port toward the cooling air space through the circulation space.

### TECHNICAL FIELD

The present invention relates to a vehicle radiative cooling device.

### BACKGROUND ART

Conventionally, air conditioning equipment such as an air conditioner is installed in a vehicle interior so that the vehicle interior can be controlled so as not to have an excessively high temperature. A conventional technique related to temperature control in a vehicle interior describes a matter of blowing air generated by an air conditioning system of a vehicle to a head side of a front seat or a rear seat through a duct provided in a pillar or a ceiling base material.

### CITATION LIST

### Patent Literature

Patent Literature 1: JP H3-109905 U

### SUMMARY OF INVENTION

### Technical Problem

The present inventors have focused on the point that the technique described in Patent Literature 1 cannot directly suppress an increase in temperature near a dashboard or the like due to solar radiation, and the point that the power consumption of the air conditioning system tends to increase when such corresponding area is cooled using the air conditioning system.

An object of the present invention is to efficiently cool a portion whose temperature can rise due to solar radiation while suppressing power consumption.

### Solution to Problem

One aspect of the present invention relates to a vehicle radiative cooling device including a roof panel, a roof trim, a cooling air space, a temperature variable portion, a pillar trim, an air intake port, a duct, and an airflow generator. The roof panel is provided with a radiative cooling layer on an outer surface thereof, the radiative cooling layer radiating far infrared rays toward the outside of the vehicle. The roof trim is disposed along a vehicle interior side surface of the roof panel. The cooling air space is configured as a space partitioned by a roof panel and a roof trim. The temperature variable portion is disposed at front or rear of the vehicle interior and is configured as a portion whose temperature can rise due to solar radiation. The pillar trim is disposed along a vehicle interior side surface of the pillar. The air intake port is disposed adjacent to the temperature variable portion in the pillar trim. A space forming member is disposed in a space surrounded by the pillar and the pillar trim between the air intake port and the cooling air space, and is configured to form a circulation space through which the fluid flowing in from the air intake port can flow. The airflow generator is disposed in the cooling air space and is configured to generate an airflow from the air intake port toward the cooling air space through the circulation space.

### BRIEF DESCRIPTION OF DRAWINGS

FIG. 1 illustrates a vehicle radiative cooling device according to an embodiment, and is a side view of the inside of a vehicle.

FIG. 2 is a cross-sectional view intersecting a longitudinal direction of a pillar in a vehicle.

### DESCRIPTION OF EMBODIMENTS

Hereinafter, embodiments of the present invention will be described with reference to the accompanying drawings. In the drawings, the same members are denoted by the same reference numerals, and redundant description will be omitted. In the drawings, the sizes of and ratios between respective members may be exaggerated to facilitate understanding of the embodiment, and may be different from the actual size and ratio.

In each drawing, arrows represented by X, Y, and Z are used to indicate the direction of the vehicle. X represents a front-rear direction of the vehicle and is referred to as a front-rear direction X. Y represents a vehicle width direction and is referred to as a vehicle width direction Y. Z represents a height direction and is referred to as a height direction Z.

The vehicle radiative cooling device according to the present embodiment can be applied to, for example, an automobile driven by an engine, an automobile driven by a secondary battery, or an automobile driven by a fuel cell.

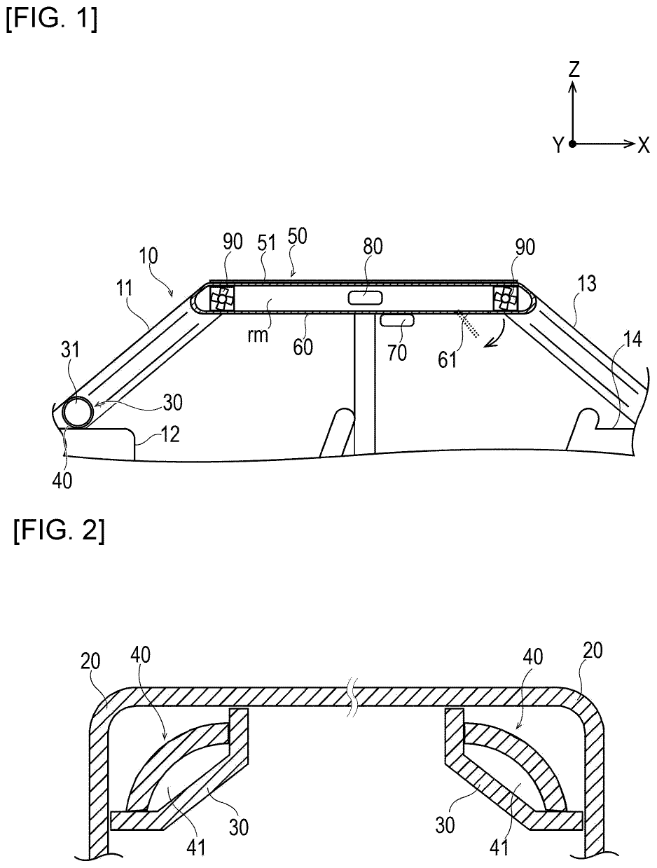

As illustrated in FIGS. 1 and 2, the configuration related to the vehicle radiative cooling device includes a temperature variable portion 10, a pillar panel 20 (corresponding to pillar), a pillar trim 30, a space forming member 40, a roof panel 50, a roof trim 60, temperature measuring instruments 70 and 80, and an airflow generator 90. Details will be described below.

### Temperature Variable Portion

The temperature variable portion 10 corresponds to a target portion cooled by the vehicle radiative cooling device according to the present embodiment. The temperature variable portion 10 is disposed at front of the vehicle interior and is configured as a portion whose temperature can rise due to solar radiation. The temperature variable portion 10 includes a windshield 11 and a dashboard 12 as exemplarily illustrated in FIG. 1 in the present embodiment.

The windshield 11 is a glass positioned at the front of the first row of the vehicle, and is formed using a known material such as soda-lime glass. The dashboard 12 is an instrument panel provided at a portion that partitions the engine and the seat in the first row of the vehicle, and can be made of a known material such as acrylonitrile butadiene styrene (ABS) or polypropylene (PP) in the present embodiment. The temperature of the temperature variable portion 10 such as the lower portion of the windshield 11 and the dashboard 12 can rise with time due to solar radiation. The vehicle radiative cooling device according to the present embodiment is configured as described below, thereby efficiently suppressing a temperature rise of the dashboard 12, the lower portion of the windshield 11, and the like.

### Pillar Panel, Pillar Trim

The pillar panel 20 corresponds to a portion adjacent to the windshield 11 in the vehicle outer side portion of the pillar. The pillar trim 30 is disposed along the vehicle interior side surface of the pillar.

As illustrated in FIG. 2, the pillar panel 20 forms a space for accommodating the space forming member 40 together with the pillar trim 30. Further, the pillar trim 30 forms an air intake port 31 for allowing a thermal fluid such as a gas having a relatively high temperature generated in the temperature variable portion 10 in the vehicle interior to flow through a cooling air space rm on the roof side (see FIG. 1).

The air intake port 31 is formed in the vicinity of an end portion on the side of the dashboard 12 or the windshield 11 constituting the temperature variable portion 10 in the pillar trim 30. One or more air intake ports 31 can be installed in each of the left and right pillar trims 30 in the vehicle width direction Y. With such a configuration, it is possible to suppress a temperature rise on the driver seat side and the passenger seat side and to efficiently suppress a temperature rise in the vehicle interior.

The material of the pillar panel 20 and the pillar trim 30 is not particularly limited as long as the space forming member 40 can be accommodated in the internal space formed by the pillar panel 20 and the pillar trim 30. As an example of the material forming the pillar panel 20 and the pillar trim 30, a known material such as a steel plate can be used for the pillar panel 20, and a known material such as polypropylene can be used for the pillar trim 30.

### Space Forming Member

The space forming member 40 is disposed in a space surrounded by the pillar panel 20 and the pillar trim 30 between the air intake port 31 and the cooling air space rm, and is configured to form a circulation space 41 through which the fluid flowing in from the air intake port 31 can flow (see FIG. 2). The space forming member 40 is disposed so as to extend along the longitudinal direction of the pillar panel 20 and the pillar trim 30.

In the present embodiment, the space forming member 40 is configured such that a cross section intersecting the longitudinal direction is formed in a substantially arc shape, and a circulation space 41 for moving the fluid from the temperature variable portion 10 to the cooling air space rm is formed therein together with the pillar trim 30. The space forming member 40 is integrally formed with the pillar trim 30 by welding or the like to form the circulation space 41 therein.

With such a configuration, it is possible to ensure a wide space through which the thermal fluid from the temperature variable portion 10 flows without requiring a rib or the like for ensuring the rigidity of the pillar. As a result, the circulation space 41 can be prepared to be relatively wide, and the pressure loss of the thermal fluid (airflow) flowing from the temperature variable portion 10 can be reduced.

The specific shape of the space forming member 40 is not limited to the arc shape described above as long as the thermal fluid from the temperature variable portion 10 can be moved from the air intake port to the cooling air space rm. The distal end portion of the space forming member 40 is located in the vicinity of the lower portion of the windshield 11 in the upper portion of the dashboard 12 of the vehicle interior.

### Roof Panel, Roof Trim

The roof panel 50 is disposed on an outer surface of a roof portion of the vehicle, and the roof trim 60 is disposed along a vehicle interior side surface of the roof panel 50. With such a configuration, a cooling air space rm which is partitioned from the vehicle interior and cools the fluid from the air intake port is formed between the roof panel 50 and the roof trim 60.

The circulation space 41 formed by the space forming member 40 and the pillar trim 30 is configured to communicate with the cooling air space rm formed by the roof panel 50 and the roof trim 60. The rear end portion of the space forming member 40 faces the inside of the cooling air space rm formed by the roof panel 50 and the roof trim 60.

The materials of the roof panel 50 and the roof trim 60 are not particularly limited, but the roof panel 50 can be made of the same material as the pillar panel 20, and the roof trim 60 can be made of the same material as the pillar trim 30.

Further, the outer surface of the roof panel 50 can be provided with a radiative cooling layer 51 that radiates far infrared rays toward the outside of the vehicle. That is, the radiative cooling layer 51 of the roof panel 50 can be configured to include a composite of resin and metal oxide particles. With such a configuration, when the thermal fluid from the temperature variable portion 10 flows through the cooling air space rm, heat of the fluid can be moved to the outside of the vehicle by radiative cooling.

### Temperature Measuring Instrument

The temperature measuring instrument 70 is used to measure the temperature in the vehicle interior. The installation place of the temperature measuring instrument 70 is not particularly limited as long as the temperature measuring instrument can measure the temperature in the vehicle interior as a measurement target, but the temperature measuring instrument can be installed on a ceiling wall or a floor of the vehicle interior as an example.

The temperature measuring instrument 80 is installed to measure a temperature of cooling air space rm surrounded by the roof panel 50 and the roof trim 60. A specific installation place of the temperature measuring instrument 80 is not particularly limited as long as the temperature measuring instrument can measure the temperature of the cooling air space rm surrounded by the roof panel 50 and the roof trim 60. For example, the temperature measuring instrument can be installed at a central portion of the cooling air space rm in the vehicle width direction Y and the front-rear direction X.

As the temperature measuring instruments 70 and 80, a thermocouple, a radiation thermometer, a glass thermometer, or the like can be used. With this configuration, it is possible to acquire data necessary for driving the airflow generator only when necessary as described below without constantly driving the airflow generator 90 by measuring the temperature of the vehicle interior and the cooling air space rm.

The temperature measuring instruments 70 and 80 and the airflow generator 90 can be controlled by a control unit installed inside the vehicle. That is, the control unit is electrically connected to the temperature measuring instruments 70 and 80 and the airflow generator 90, and can perform control to drive the airflow generator 90 when the temperature of the temperature variable portion 10 measured by the temperature measuring instrument 70 exceeds a predetermined threshold temperature.

### Airflow Generator

The airflow generator 90 is disposed in the cooling air space rm, and is configured to generate an airflow from the air intake port 31 toward the cooling air space rm through the circulation space 41 of the space forming member 40. As shown in FIG. 1, the airflow generator 90 can be installed near the boundary between the circulation space 41 and the cooling air space rm and on the vehicle rear side of the cooling air space rm.

By installing the airflow generator 90 at the vehicle rear side of the cooling air space rm, a pressure difference of air (fluid) is generated in the cooling air space rm, and a thermal fluid having a relatively high temperature can be guided from the temperature variable portion 10 to the rear side of the cooling air space rm. As a result, the thermal fluid generated in the temperature variable portion 10 can be radiationally cooled in the entire cooling air space rm.

Further, by disposing the airflow generator 90 near the boundary between the space forming member 40 and the cooling air space rm, a pressure difference of air (fluid) is generated in the circulation space, and hot air that can be generated in the temperature variable portion 10 can be efficiently guided to the cooling air space rm. As a result, the thermal fluid generated in the temperature variable portion 10 can be efficiently radiationally cooled.

The airflow generator 90 can be controlled by the control unit to be driven in a case where the temperature of the cooling air space rm measured by the temperature measuring instrument 80 is lower than the temperature inside the vehicle interior measured by the temperature measuring instrument 70. As a result, when the outside air temperature is high such as summer, the temperature rise in the vehicle interior is suppressed by the airflow generator 90, and when the outside air temperature is low such as winter, the airflow generator 90 is not driven, so that the airflow generator 90 can be efficiently used to prevent the temperature drop in the vehicle interior from being inadvertently caused.

The airflow generator 90 can be configured to discharge air (fluid) in the cooling air space rm into the vehicle interior from behind the roof trim when the temperature of the cooling air space rm is lower than the temperature in the vehicle interior. Although the roof trim 60 partitions the cooling air space rm of the roof from the vehicle interior, the roof trim 60 can be provided with an opening and closing part 61 that is operable to open when the fluid flows through the cooling air space rm and close when the air stops.

When the temperature of the cooling air space is lower than the vehicle interior temperature, the control unit can operate the airflow generator 90 to open the opening and closing part 61 by the air generated by the airflow generator 90 and discharge the air in the cooling air space rm into the vehicle interior. With such a configuration, the fluid cooled in the cooling air space rm is circulated in the vehicle interior, whereby the temperature in the vehicle interior can be lowered.

The specific configuration of the airflow generator 90 is not particularly limited as long as the airflow generator can generate an airflow passing from the air intake port 31 through the pillar to flow through the cooling air space rm of the roof. For example, the airflow generator can be configured such that the fan is operated by a known motor. With such a configuration, hot air generated in the temperature variable portion 10 enters the cooling air space rm from the air intake port 31 through the circulation space 41 of the space forming member 40, and is radiated to the outside of the vehicle through the radiative cooling layer 51.

As a result, it is possible to efficiently suppress heat transfer from the temperature variable portion 10 to the space in the vehicle interior. Therefore, it is possible to suppress a temperature rise in the interior caused by the dashboard 12, the windshield 11, and the like constituting the temperature variable portion 10 and to enhance the comfort in the vehicle interior. As described above, in the present embodiment, the temperature rise in the vehicle interior is suppressed by the airflow generator 90 instead of the air conditioner system, so that the power consumption can be reduced.

Note that the present invention is not limited to the above-described embodiments, and various modifications can be made within the scope of the claims. Although it has been described above that the temperature variable portion 10 uses the airflow generator 90 with the windshield 11 and the dashboard 12 as cooling targets, the present invention is not limited thereto. In addition to the above, the air intake port is disposed in a rear pillar trim located in the vicinity of a portion such as a rear window 13 or a tonneau board 14 in which the temperature can rise due to solar radiation from the rear window 13 in the rear of the vehicle illustrated in FIG. 1. Then, the space forming member may be disposed in the internal spaces of the rear pillar panel and the rear pillar trim, and heat moving from the air intake port through the circulation space formed by the rear pillar trim and the space forming member may be moved to the cooling air space of the roof by the airflow generator and radiationally cooled.

In addition, the following embodiments are also included in the scope of the present invention: the vehicle radiative cooling device according to claim 1, wherein the vehicle radiative cooling device has the feature of claim 2; the vehicle radiative cooling device according to claim 1 or 2, wherein the vehicle radiative cooling device has the feature of claim 3; the vehicle radiative cooling device according to any one of claims 1 to 3, wherein the vehicle radiative cooling device has the feature of claim 4; the vehicle radiative cooling device according to any one of claims 1 to 4, wherein the vehicle radiative cooling device has the feature of claim 5; the vehicle radiative cooling device according to any one of claims 1 to 5, wherein the vehicle radiative cooling device has the feature of claim 6; the vehicle radiative cooling device according to any one of claims 1 to 6, wherein the vehicle radiative cooling device has the feature of claim 7; the vehicle radiative cooling device according to claim 7, wherein the vehicle radiative cooling device has the feature of claim 8; and the vehicle radiative cooling device according to any one of claims 1 to 8, wherein the vehicle radiative cooling device has the feature of claim 9.

### REFERENCE SIGNS LIST

10 Temperature variable portion
11 Windshield
12 Dashboard
20 Pillar panel (pillar)
30 Pillar trim
31 Air intake port
40 Space forming member
41 Circulation space
50 Roof panel
51 Radiative cooling layer
60 Roof trim
7080 Temperature measuring instrument
90 Airflow generator
rm Cooling air space

1. A vehicle radiative cooling device comprising:
a roof panel of a vehicle provided with a radiative cooling layer on an outer surface, the radiative cooling layer emitting far infrared rays toward an outside of the vehicle;
a roof trim disposed along a vehicle interior side surface of the roof panel;
a cooling air space that is a space partitioned by the roof panel and the roof trim;
a temperature variable portion disposed at the front or rear of the vehicle interior and whose temperature can rise due to solar radiation;
a pillar trim disposed along the vehicle interior side surface of a pillar; an air intake port disposed adjacent to the temperature variable portion in the pillar trim;
a space forming member disposed in a space between the air intake port and the cooling air space, surrounded by the pillar and pillar trim and forming a circulation space through which a fluid flowing in from the air intake port can circulate; and
an airflow generator disposed in the cooling air space and generating an air flow from the air intake port toward the cooling air space through the circulation space.

2. The vehicle radiative cooling device according to claim 1, wherein the temperature variable portion is a dashboard or a lower portion of a windshield that can be heated to a high temperature by solar radiation.

3. The vehicle radiative cooling device according to claim 1, wherein one or more air intake ports are installed in each of the left and right pillar trims in the vehicle.

4. The vehicle radiative cooling device according to claim 1, wherein the space forming member is integrally formed with the pillar trim to form the circulation space therein.

5. The vehicle radiative cooling device according to claim 1, wherein the airflow generator is installed at a vehicle rear side of the cooling air space.

6. The vehicle radiative cooling device according to claim 1, wherein the airflow generator is installed near a boundary between the space forming member and the cooling air space.

7. The vehicle radiative cooling device according to claim 1, wherein the airflow generator is driven when a temperature of the cooling air space is lower than a temperature inside the vehicle interior.

8. The vehicle radiative cooling device according to claim 7, wherein the temperature in the vehicle interior is measured by a thermocouple, a radiation thermometer, or a glass thermometer.

9. The vehicle radiative cooling device according to claim 1, wherein the airflow generator discharges air in the cooling air space into the vehicle interior from behind the roof trim when a temperature of the cooling air space is lower than a vehicle interior temperature.

10. The vehicle radiative cooling device according to claim 9, wherein the roof trim includes an opening and closing part that is opened to allow air to flow through the cooling air space and is closed when the air stops.
